(19) United States
(12) Patent Application Publication
(10) Pub. No.: US 2007/0072089 A1
(43) Pub. Date: Mar. 29, 2007

(54) Holographic recording medium

(75) Inventors: Norikatsu Sasao, Tokyo (JP); Akiko Hirao, Chiba-shi (JP); Rumiko Hayase, Yokohama-shi (JP); Kazuki Matsumoto, Kawasaki-shi (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/527,714

(22) Filed: Sep. 27, 2006

(30) Foreign Application Priority Data
Sep. 27, 2005 (JP) 2005-279430

(51) Int. Cl. G03H 1/04; G03C 1/00

(52) U.S. Cl. 430/1; 430/2; 430/281.1

(57) ABSTRACT

A holographic recording medium has a recording layer, the recording layer including a matrix material, a polymerizable monomer having at least one ethylenic unsaturated bond, a photo-iniferter, and a photoinitiator.

### CROSS-REFERENCE TO RELATED APPLICATIONS

This application is based upon and claims the benefit of priority from prior Japanese Patent Application No. 2005-279430, filed Sep. 27, 2005, the entire contents of which are incorporated herein by reference.

### BACKGROUND OF THE INVENTION

1. Field of the Invention

The invention relates to a holographic recording medium, and a method of manufacturing a master hologram and a method of manufacturing a copy hologram out of the master hologram.

2. Description of the Related Art

Holographic memory that holds data in a form of holography is capable to record data in high capacity. Much attention has been paid on the development of such material that enables to record data holographically. Such materials include Omnidex [registered trademark, DuPont Company] which is one type of photosensitive polymer film (photopolymer). In this case, a photoactive monomer, a photoinitiator and a sensitizing dye are well dispersed throughout a thermoplastic binder to form a photopolymer. When interference pattern is exposed into the photopolymer layer, the photoinitiator at high optical field, i.e., the bright region, decompose to give initiating radicals and radical polymerization initiate. Because the photoactive monomer diffuses from the dark regions to the bright regions, further polymerization in the bright regions is promoted and polymers with high molecular weight are achieved in such regions. This leads to differences in density and in refractive index in the photopolymer that follows the profile of the interference pattern exposed, and this is how hologram is recorded.

A holographic recording medium in which a photoactive monomer is dispersed in a cross-linked polymeric matrix is disclosed in JP-A 11-252303 (KOKAI). Furthermore, a holographic recording medium in which a photoactive monomer is dispersed in an epoxy resin matrix is also proposed (see T. J. Trentler et al, Proceedings of SPIE, 2001, Vol. 4296, pp. 259-266).

The present inventors have revealed from experiments that, in the holographic recording medium where a photoactive monomer and a photoinitiator are dispersed in a cross-linked polymeric matrix, chemical reaction proceeds within the medium even after the recording process. In such holographic recording medium, the configuration of the recorded hologram deforms soon after recording. This would lower the signal-to-noise ratio (SNR) of the reconstructed image from the recorded hologram and would result in high cross-talks between the data between the adjacent pages when data pages were multiplexed.

Generally, it is difficult to terminate a radical polymerization at the desired moment that has once initiated. The same is true for the holographic recording which operates under such reaction. To prevent an excess polymerization, one can add an inhibitor together with a monomer, a photoinitiator and binders however, termination by the added inhibitor occurs randomly. This would lead to terminations in the bright region, where propagation of the polymer is desired. Up to now, it is still a big issue to record the exposed interference pattern accurately into the recording medium.

### BRIEF SUMMARY OF THE INVENTION

A holographic recording medium according to an aspect of the invention comprises a recording layer in which the recording layer comprises: a matrix material; a polymerizable monomer having at least one ethylenic unsaturated bond; a photo-iniferter; and a photoinitiator.

A method of fabricating a master hologram according to another aspect of the invention comprises: exposing the recording layer of the holographic recording medium described above with information beam and the first reference beam collinearly; and exposing the recording layer with the second reference beam at an angle different from that of the information beam so that the information beam, the first reference beam and the second reference beam intersect in the recording layer to record the interference pattern caused by the three beams.

A method of fabricating a copy hologram according to another aspect of the invention comprises: arranging the master hologram and a holographic recording medium parallel to each other; exposing the master hologram to reconstruct the diffraction light beam with the second reference beam at the angle equal to that when the master hologram was fabricated; and exposing the recording layer of the holographic recording medium that has been set parallel to the master hologram with the reconstructed diffraction light to fabricate a copy hologram.

### BRIEF DESCRIPTION OF THE SEVERAL VIEWS OF THE DRAWING

FIG. 1 is a cross-sectional view of a transmission holographic recording medium according to an embodiment;

FIG. 2 is a schematic view of a transmission holographic recording/reconstructing apparatus according to an embodiment;

FIG. 3 is a cross-sectional view of a reflection holographic recording medium according to an embodiment;

FIG. 4 is a schematic view of a reflection holographic recording/reconstructing apparatus according to an embodiment;

FIG. 5 is a schematic view of a reflection holographic recording/reconstructing apparatus according to an embodiment;

FIG. 6 is a cross-sectional view showing a method to fabricate a master hologram according to an embodiment;

FIG. 7 is a cross-sectional view showing a method to fabricate a copy hologram according to an embodiment;

FIG. 8 is a cross-sectional view showing a method to fabricate a master hologram according to an embodiment;

FIG. 9 is a cross-sectional view showing a method to fabricate a copy hologram according to an embodiment; and

FIG. 10 is a plot showing the angle selectivity of diffraction efficiency for an ideal hologram.

### DETAILED DESCRIPTION OF THE INVENTION

The invention will be described in details below.

[Holographic Recording Medium]

The components that form the recording layer of the holographic recording medium according to embodiments of the invention will be described below.

A polymeric matrix is preferably cross-linked. Examples of the polymerization reaction to form the polymeric matrix include cationic polymerization of an epoxy compounds, cationic polymerization of vinyl ethers, epoxy-amine polymerization, epoxy-anhydride polymerization and epoxy-mercaptan polymerization.

A suitable polymeric matrix is a cured resin obtained by the reaction between an epoxy compound and a curing agent.

Examples of the epoxy compounds include 1,4-butanediol diglycidyl ether, 1,6-hexanediol diglycidyl ether, diethylene glycol diglycidyl ether, polyethylene glycol diglycidyl ether, polypropylene glycol diglycidyl ether, neopentyl glycol diglycidyl ether, diepoxy octane, resorcinol diglycidyl ether, diglycidyl ether of bisphenol A, diglycidyl ether of bisphenol F, 3,4-epoxycyclohexenylmethyl-3′,4′-epoxycyclohexenecarboxylate and epoxypropoxypropyl-terminated polydimethyl cyclohexane.

Curing agents for the epoxy compounds include amines, phenols, organic acid anhydrides and amides. More specifically, examples of the curing agents include ethylenediamine, diethylenetriamine, triethylenetetraamine, tetraethylenepentaamine, pentaethylenehexaamine, hexamethylenediamine, menthenediamine, isophoronediamine, bis (4-amino-3-methyldicyclohexyl)methane, bis (aminomethyl)cyclohexane, N-aminoethylpiperazine, m-xylenediamine, 1,3-diaminopropane, 1,4-diaminobutane, trimethylhexamethylenediamine, imino bis (propylamine), bis(hexamethylene)triamine, 1,3,6-tris(aminomethyl)hexane, dimethylaminopropylamine, aminoethylethanolamine, tris(methylamino)hexane, m-phenylenediamine, p-phenylenediamine, diaminodiphenylmethane, diaminodiphenylsulfone, 3,3′-diethyl-4,4′-diaminodiphenylmethane, maleic anhydride, succinic anhydride, tetrahydrophthalic anhydride, methyltetrahydro phthalic anhydride, methylnadic anhydride, hexahydrophthalic anhydride, methylhexahydrophthalic acid, methylcyclohexenetetracarboxylic anhydride, phthalic anhydride, trimellitic anhydride, benzophenonetetracarboxylic anhydride, dodecenylsuccinic anhydride, ethylene glycol bis(anhydrotrimellitate), phenol novolak resin, cresol novolak resin, polyvinylphenol, terpene phenolic resin and polyamide resin.

A curing catalyst may also be added to the recording layer, if necessary. Such catalysts include tertiary amines, organic phosphine compounds, imidazole compounds and derivatives thereof. More specifically, examples of the curing catalysts include triethanolamine, piperidine, N,N′-dimethylpiperazine, 1,4-diazabicyclo(2,2,2)octane(triethylenediamine), pyridine, picoline, dimethylcyclohexylamine, dimethylhexylamine, benzyldimethylamine, 2-(dimethylaminomethyl)phenol, 2,4,6-tris(dimethylaminomethyl)phenol, 1,8-diazabicyclo[5,4,0]undec-7-ene (DBU) or a phenol salt thereof, trimethylphosphine, triethylphosphine, tributylphosphine, triphenylphosphine, tris(p-methylphenyl)phosphine, 2-methylimidazole, 2,4-dimethylimidazole, 2-ethyl-4-methylimidazole, 2-phenylimidazole, 2-phenyl-4-methylimidazole, and 2-heptaimidazole. Latent catalyst such as boron trifluoride-amine complex, dicyandiamide, organic acid hydrazide, diaminomaleonitrile and derivatives thereof, melamine and derivatives thereof and amine imide are also favorable if necessary. Adding a compound having active hydrogen such as phenols or salicylic acid could help to promote curing.

Monomers having at least one ethylenic unsaturated bond include, for example, an unsaturated carboxylic acid, an unsaturated carboxylic acid ester, an unsaturated carboxylic acid amide, and a vinyl compound. More specifically, examples of the photoactive monomers include acrylic acid, methyl acrylate, ethyl acrylate, propyl acrylate, butyl acrylate, isobutyl acrylate, 2-ethylhexyl acrylate, octyl acrylate, lauryl acrylate, stearyl acrylate, cyclohexyl acrylate, bicyclopentenyl acrylate, phenyl acrylate, 2,4,6-tribromophenyl acrylate, isobornyl acrylate, adamantyl acrylate, methacrylic acid, methyl methacrylate, propyl methacrylate, butyl methacrylate, phenyl methacrylate, phenoxyethyl acrylate, chlorophenyl acrylate, adamantyl methacrylate, isobornyl methacrylate, N-methylacrylamide, N,N-dimethylacrylamide, N,N-methylenebisacrylamide, acryloylmorpholine, vinylpyridine, styrene, bromostyrene, chlorostyrene, tribromophenyl acrylate, trichlorophenyl acrylate, tribromophenyl methacrylate, trichlorophenyl methacrylate, vinyl benzoate, 3,5-dichloro vinyl benzoate, vinylnaphthalene, vinyl naphthoate, naphtyl methacrylate, naphtyl acrylate, N-phenylmethacrylamide, N-phenylacrylamide, N-vinylpyrrolidinone, N-vinylcarbazole, 1-vinylimidazole, bicyclopentenyl acrylate, 1,6-hexanediol diacrylate, pentaerythritol triacrylate, pentaerythritol acrylate, pentaerythritol tetracrylate, dipentaerythritol hexacrylate, diethylene glycol diacrylate, polyethylene glycol diacrylate, polyethylene glycol dimethacrylate, tripropylene glycol diacrylate, propylene glycol trimethacrylate, diallyl phthalate, and triallyl trimellitate.

The amount of the photoactive monomer added is preferably 1 to 50 wt %, more preferably 3 to 30 wt %, of the recording layer. Sufficient change in the refractive index can be achieved if the amount of the monomer is over 1 wt %. Volume shrinkage can be made little having the amount of monomer less than 50 wt %. Small volume shrinkage leads to high resolution of the reconstructed image.

The photo-iniferter in the recording layer allows polymerization to proceed livingly in the bright region. The expression “living polymerization” is described as follows. In the living polymerization reaction, an atomic group impairing activity of a propagating chain terminal, which is called a deactivating species herein, is always present in the vicinity of the propagating chain terminal. When energy such as heat or light is not supplied, the propagating chain terminal forms a bond with the deactivating species and turns itself to a dormant species, thereby terminating the propagation. The bonding energy between the deactivating species and the propagating chain terminal is relatively small and, when energy is supplied again, the deactivating species will dissociate from the propagating chain terminal. The remaining propagating chain terminal is once again active. This will restart the propagation of the polymer. The dormant species and the propagating radicals are in equilibrium, which makes the overall concentration of the latter exceedingly small and therefore making the bimolecular termination unlikely. It follows that the propagating chain terminal continues to be active as far as energy is supplied thereto. Thus, the particular polymerization is referred to as the living polymerization.

On the contrary, since energy is not supplied in the dark regions, the photo-iniferter acts as a polymerization inhibitor in such areas. Therefore, the polymerization which has initiated in the bright regions of the interference pattern, is terminated at the interfaces between the bright regions and the dark regions, thereby recording the interference pattern that is exposed with high accuracy.

The photo-iniferters include compounds represented by, for example, the following general formulas: R₁—S—R₂, R₃—S—S—R₄, or R₅—(C—S—C(═S)—N—(R₆)ₙ, where each of R₁, R₂, R₃, and R₄ is a substituent having a phenyl group, a thiocarbonyl group or a benzoyl group, R₅ is a phenyl group, R₆ is an alkyl group, and n is an integer of 2 to 4. More specifically, examples of the photo-iniferters include diphenyl sulfide, diphenyl disulfide, bis(N,N-diethylthiocarbamoyl) disulfide, dibenzoyl disulfide, benzyl N,N-diethyldithiocarbamate, p-xylene bis(N,N-diethyldithiocarbamate), 1,2,4,5-tetrakis(N,N-diethyldithiocarbamylmethyl)benzene. The chemical formulas of the typical photo-iniferters are as follows:

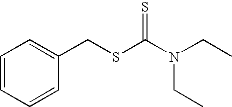

benzyl N,N-diethyldithiocarbamate

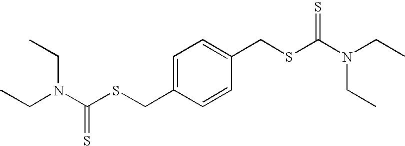

p-xylene bis(N,N-diethyldithiocarbamate)

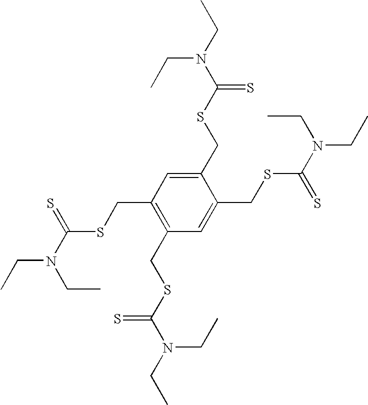

1,2,4,5-tetrakis(N,N-diethyldithiocarbamylmethyl)benze ne

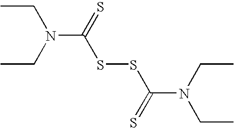

bis(N,N-diethyltiocarbamoyl) disulfide

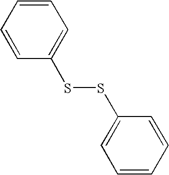

diphenyl disulfide

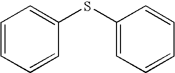

diphenyl sulfide

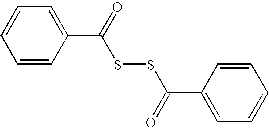

dibenzoyl disulfide

The amount of the photo-iniferter is preferably 0.3 to 12 mol %, more preferably 1.5 to 6 mol %, to the photoactive monomer. Having the amount of the photo-iniferter 0.3 mol % or more to the photoactive monomer, the photo-iniferter can sufficiently generate the living radical polymerization. When the amount of the photo-iniferter is 12 mol % or less to the photoactive monomer, sufficient transmittance can be achieved.

Adding photoinitiators is helpful to improve the sensitivity. The photoinitiators can be selected in accordance with the wavelength of the light used for recording. Examples of the photoinitiators include benzoin ether, benzyl ketal, benzyl, acetophenone derivatives, amino acetophenones, benzophenone derivatives, acyl phosphine oxides, triazines, imidazole derivatives, organic azide compounds, titanocenes, organic peroxides and thioxanthone derivatives. More specifically, the photoinitiator include benzyl, benzoin, benzoin ethyl ether, benzoin isopropyl ether, benzoin isobutyl ether, 1-hydroxycyclohexyl phenyl ketone, benzyl methyl ketal, benzyl ethyl ketal, benzyl methoxyethyl ether, 2,2′-diethylacetophenone, 2,2′-dipropylacetophenone, 2-hydroxy-2-methylpropiophenone, p-tert-butyltrichloroacetophenone, thioxanthone, 1-chlorothioxanthone, 2-chlorothioxanthone, 2-methylthioxanthone, 2-isopropylthioxanthone, 3,3′,4,4′-tetrakis(t-butylperoxycarbonyl)benzophenone, 2,4,6-tris(trichloromethyl)-1,3,5-triazine, 2-(p-methoxyphenyl)-4,6-bis(trichloromethyl)-1,3,5-triazine, 2-[(p-methoxyphenyl)ethylene]-4,6-bis(trichloromethyl)-1,3,5-triazine, diphenyl-(2,4,6-trimethylbenzoyl) phosphineoxide, Irgacure [registered trademark] 149, 184, 369, 651, 784, 819, 907, 1700, 1800, 1850, and so forth, available from Ciba Specialty Chemicals, di-t-butylperoxide, dicumylperoxide, t-butylcumylperoxide, t-butylperoxy acetate, t-butylperoxy phthalate, t-butylperoxy benzoate, acetylperoxide, isobutylperoxide, decanoylperoxide, lauroylperoxide, benzoylperoxide, t-butylhydroperoxide, cumene hydroperoxide, methyl ethyl ketoneperoxide and cyclohexanoneperoxide. Titanocene compound such as Irgacure [registered trademark] 784 (Ciba Specialty Chemicals) is preferable for photoinitiator when blue laser beam is used for recording.

The amount of the photoinitiator is preferably 0.1 to 20 wt %, more preferably 0.2 to 10 wt %, of the recording layer. Having the amount of the photoinitiator 0.1 wt % or more, sufficient change in the refractive index can be achieved. When the amount of the photoinitiator is 20 wt % or less, light absorption would be small enough to achieve high sensitivity and high diffraction efficiency.

The concentration of the photo-iniferter and the photoinitiator is preferably set so that the transmittance of the recording beam through the holographic recording medium lies in between 10% to 95%, more preferably 20% to 90%. Having the transmittance 10% or more, high sensitivity and high diffraction efficiency can be achieved. When the transmittance is 95% or less, scattering of the recording beam can be prevented, making it possible to record data accurately.

It is also favorable to add, if necessary, sensitizing dyes, such as cyanine, merocyanine, xanthene, cumarin and eosine. Silane coupling agents and plasticizers can also be added.

The holographic recording medium according to an embodiment of the invention is fabricated by the method described below. A solution of the recording layer material is prepared by mixing a polymeric matrix precursur, a monomer, a photo-iniferter, and some other components. A substrate is coated with the solution of the recording layer material, where the polymeric matrix is cross-linked to form the recording layer. The substrate can either be of glass or of plastic. The method of coating the substrate with the solution of the recording layer material includes casting and spin-coating. One can also use a method in which two glass substrates or plastic substrates are arranged with a resin spacer interposed therebetween and the solution of the recording layer material is injected into the gap between the two substrates. In the case of using an aliphatic primary amine as the curing agent, the cross-linkage of the polymeric matrix proceeds even under room temperature. However, it is possible to heat the recording layer material to about 30 to 150° C. according to the reactivity of the curing agent. The thickness of the recording layer is preferably 20 μm to 2 mm, more preferably 50 μm to 1 mm. Having the recording layer with thickness of 20 μm or more, sufficient memory capacity in the recording media can be achieved. Having the recording layer with thickness of 2 mm or less, high sensitivity and high diffraction efficiency can be achieved.

[Recording/reconstructing method]

According to an embodiment of the invention, holographic recording is carried out by allowing information beam and reference beam to interfere with each other within the recording layer of the holographic recording medium. Hologram that is to be recorded may be either transmission hologram or reflection hologram. The information beam and the reference beam can be interfered either by a two-axis geometry, where the two beams are incident on a holographic recording medium from angles different from each other, or by a collinear interference method where the two beams are incident on a holographic recording medium from the same angle.

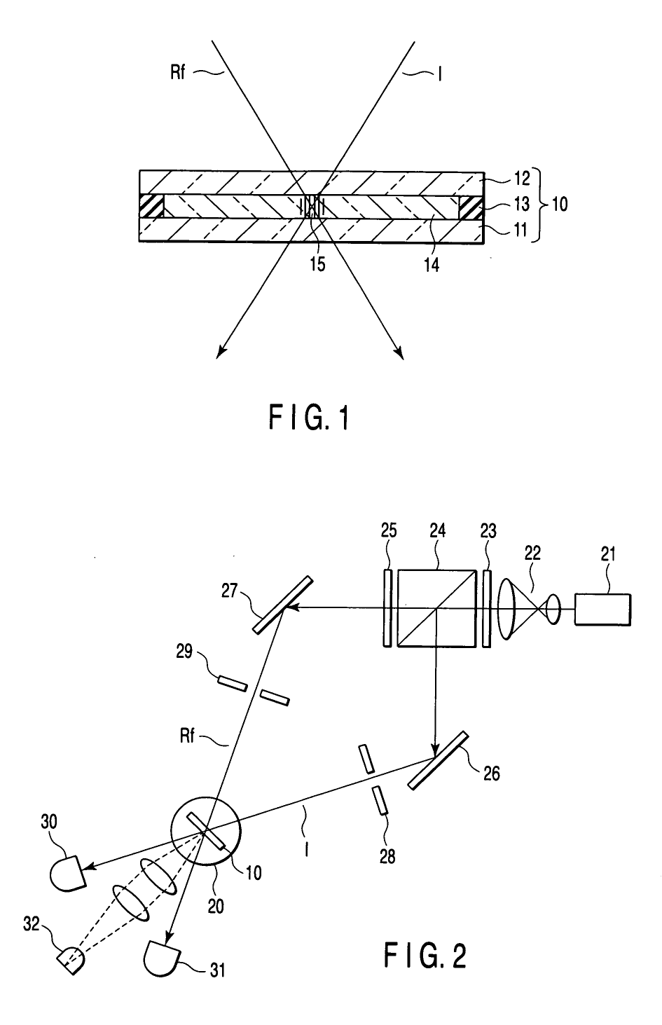

FIG. 1 is a cross-sectional view showing a transmission holographic recording medium 10 used for a two-axis method according to an embodiment of the invention. The holographic recording medium 10 comprises a pair of transparent substrates 11, 12 arranged with a spacer 13 interposed therebetween to form a prescribed gap, where the recording layer 14 is disposed. The recording layer 14 comprises a photoactive monomer having at least one ethylenic unsaturated bond, and a photo-iniferter dispersed in a polymeric matrix. The transmission holographic recording medium 10 is exposed to an information beam I and a reference beam Rf. The information beam I and the reference beam Rf intersect and interfere with each other in the recording layer 14 to form a transmission hologram in a refractive index-modulated region 15 as shown in the figure.

FIG. 2 is a schematic diagram showing an example of a transmission holographic recording/reconstructing apparatus according to an embodiment of the invention. The holographic recording/reconstructing apparatus is based on transmission two-axis holography. The holographic recording medium 10 is mounted on a rotation stage 20. The light source device 21 may be of any light source that emits light capable to interfere in the recording layer 14 of the holographic recording medium 10. Linearly polarized laser beam is desirable, for coherent beam is essential. Examples of the lasers include a semiconductor laser, a He—Ne laser, an argon laser and a YAG laser. The light beam emitted from the light source device 21 is incident on a polarizing beam splitter 24 via a beam expander 22 and a polarizer 23. The beam expander 22 expands the light beam emitted from the light source device 21 to the diameter adapted for the holographic recording. The polarizer 23 rotates the plane of polarization of the light beam that has been expanded through the beam expander 22 so as to generate a light beam including an S-polarized beam and a P-polarized beam. For polarizer 23, a half-wave plate or a quarter-wave plate, for example, may be used.

Of the light beam that has passed through the wave plate 23, the S-polarized beam is reflected by the polarizing beam splitter 24 which is used as the information beam I, and the P-polarized beam is transmitted through the polarizing beam splitter 24 which is used as the reference beam Rf. It should be noted that the rotation direction of the plane of polarization of the light beam incident on the polarizing beam splitter 24 is controlled by the wave plate 23. By controlling the wave plate 23, the intensities of the information beam I and the reference beam Rf can be made equal at the position of the recording layer 14 of the holographic recording medium 10.

The information beam I that has been reflected by the polarizing beam splitter 24 is reflected by the mirror 26, which then passes through an electromagnetic shutter 28 to be exposed into the recording layer 14 of the holographic recording medium 10 mounted on the rotation stage 20.

On the other hand, the reference beam Rf which has transmitted through the polarizing beam splitter 24 is incident on a wave plate 25 where the polarization direction thereof is rotated 90° to form an S-polarized light beam. The reference beam Rf is reflected by a mirror 27, which then passes through an electromagnetic shutter 29 to be exposed into the recording layer 14 of the holographic recording medium 10, mounted on the rotation stage 20, in such a way so that the reference beam intersects with the information beam I therein. As a result, a transmission hologram is formed in the refractive index-modulated region 15.

In order to reconstruct the recorded data, the electromagnetic shutter 28 is closed to shut off the information beam I and only allows the reference beam Rf to be exposed to the refractive index-modulated region 15 of the transmission hologram which has been formed within the recording layer 14 of the holographic recording medium 10. When passing through the holographic recording medium 10, the reference beam Rf is partly diffracted by the transmission hologram. The diffracted light beam is detected by a photodetector 30. A photodetector 31, which is to monitor the light beam transmitting through the holographic recording medium 10, is also provided.

In order to polymerize the unreacted photoactive monomer after the holographic recording, an ultraviolet light source device 32 and an optical system for ultraviolet light exposure may be provided as shown in FIG. 2. The completion of the polymerization of the monomer stabilizes the recorded hologram. Any light source that emits light that is capable of polymerizing the unreacted photoactive monomer may be used as the ultraviolet light source device 32. Taking the efficiency to emitting ultraviolet light into account, it is preferable to use, for example, a xenon lamp, a mercury lamp, a high-pressure mercury lamp, a mercury xenon lamp, a gallium nitride-based light emitting diode, a gallium nitride-based semiconductor laser, an excimer laser, third harmonic generation (355 nm) of a Nd:YAG laser, and fourth harmonic generation (266 nm) of a Nd:YAG laser as the ultraviolet light source 32.

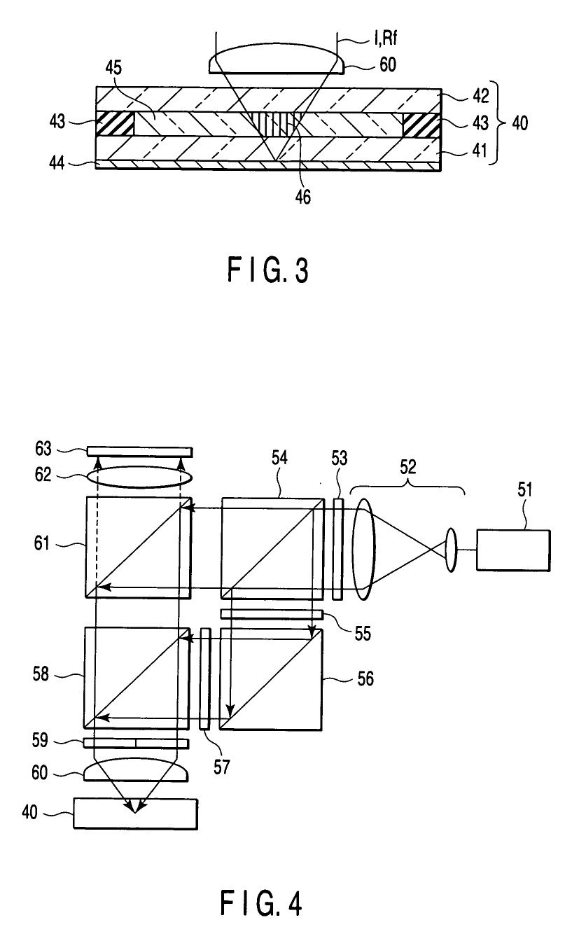

FIG. 3 is a cross-sectional view showing a holographic recording medium 40 according to an embodiment of the invention. The holographic recording medium 40 comprises: a pair of transparent substrates 41, 42 arranged with a spacer 43 interposed therebetween to form a prescribed gap, a reflective layer 44 formed on the transparent substrate 41, and a recording layer 45 disposed in the gap between the transparent substrates 41 and 42. A protective layer may be provided under the reflective layer. The recording layer 45 contains a photoactive monomer having at least one ethylenic unsaturated bond and a photo-iniferter; both well-dispersed in a polymeric matrix. The information beam I and the reference beam Rf that have passed through an objective lens 60 are both incident on the holographic recording medium 40, collinearly. The information beam I and the reference beam Rf interfere with each other in the recording layer 45 to form a hologram which forms a refractive index-modulated region 46.

FIG. 4 is a schematic diagram showing an example of a reflection holographic recording/reconstructing apparatus according to an embodiment of the invention. Like the case of the transmission holographic recording/reconstructing apparatus, it is preferable to use lasers that emit coherent and linearly polarized light beam for a light source device 51. Examples of the lasers include a semiconductor laser, a He-Ne laser, an argon laser and a YAG laser. The light beam emitted from the light source device 51 is expanded by a beam expander 52 and is incident on a wave plate 53 as a parallel beam. The wave plate 53 rotates the plane of polarization of the light beam or converts the light beam into a circular polarized light beam or an elliptical polarized light beam. The wave plate 53 generates a light beam including the P-polarized component and the S-polarized component. For the wave plate 53, a half-wave plate or a quarter-wave plate, for example, may be used.

Of the light beam that has transmitted through the wave plate 53, the S-polarized beam is reflected by the polarizing beam splitter 54 and is incident on a transmission spatial light modulator 55. This S-polarized beam later will be incident on the holographic recording medium 40 as the information beam I.

Of the light beam that has transmitted through the wave plate 53, the P-polarized beam passes through the polarizing beam splitter 54 which is used as the reference beam Rf as described below.

The transmission spatial light modulator 55 comprises a large number of pixels that are arrayed in a matrix like a transmission liquid crystal display, and the light emitted from each pixel can be switched to the P-polarized beam or to the S-polarized beam. In this manner, the transmission spatial light modulator 55 emits the information beam in which two-dimensional distribution of the plane of polarization is imparted corresponding to the data to be recorded.

The information beam that has passed through the transmission spatial light modulator 55 is incident on a polarizing beam splitter 56. The polarizing beam splitter 56 only reflects the S-polarized beam in the information beam and transmits the P-polarized beam. The S-polarized beam reflected by the polarizing beam splitter 56 passes through an electromagnetic shutter 57 in the form of the information beam having a two-dimensional distribution of intensity imparted thereto. The information beam is then incident on a polarizing beam splitter 58. The information beam is reflected by the polarizing beam splitter 58 which is then incident on a split wave plate 59.

The so-called split wave plate 59 has different optical characteristics on its right-half and its left-half as shown in FIG. 4. The plane of polarization of the beam which is incident on the right half of the split wave plate 59, is rotated by +45°. On the other hand, the plane of polarization beam that is incident on the left half of the split wave plate 59 is rotated by −45°. For the polarized beam, where plane of rotation is rotated +45° to the S-polarized beam (or the polarized beam whose plane of rotation is rotated −45° to the P-polarized beam), we refer to A-polarized beam hereinafter. Likewise, for the polarized beam where the plane of rotation is rotated −45° to the S-polarized beam (or the polarized beam whose plane of rotation is rotated +45° to the P-polarized beam), we refer to B-polarized beam hereinafter. A half-wave plate, for example, is used for each half of the split wave plate 59.

The A-polarized beam and the B-polarized beam which have transmitted through the split wave plate 59 are incident on the holographic recording medium 40 through an objective lens 60. The two beams pass through the transparent substrate 42, the recording layer 45 and the transparent substrate 41 and are focused on the reflective layer 44.

On the other hand, the P-polarized beam (the reference beam) that has transmitted through the polarizing beam splitter 54 is partly reflected by the beam splitter 61 to pass through the polarizing beam splitter 58. The reference beam that has transmitted through the polarizing beam splitter 58 is incident on the split wave plate 59. The plane of polarization of the light beam, which is incident on the right half of the split wave plate 59, is rotated by +45° and is converted to B-polarized beam as it passes through the split wave plate 59. On the contrary, the beam component which is incident on the left half of the split wave plate 59 is rotated by −45° and is converted to A-polarized beam as it passes through the split wave plate 59. The A-polarized beam and the B-polarized beam are incident on the holographic recording medium 40 through the objective lens 60 which then passes through the transparent substrate 42, the recording layer 45 and the transparent substrate 41. The two beams are focused on the reflective layer 44.

As described above, at the right half of the split wave plate, the information beam is converted to A-polarized beam, whereas the reference beam is converted to B-polarized beam. On the contrary, at the left half of the split wave plate, the information beam is converted to B-polarized beam, whereas the reference beam is converted to A-polarized beam. The information beam and the reference beam are focused on the reflective layer 44 of the holographic recording medium 40. Thus, interference occurs between the information beam incident on the recording layer 45, deriving directly through several optical instruments from the light source 51 as stated above, and the reference beam that has been reflected back by the reflective layer 44. The same is true for the interference between the reference beam deriving directly from the light source 51 and the information beam that has been reflected back by the reflective layer 44. By this way, distribution of optical properties that characterizes the information beam is represented in the recording layer 45. On the other hand, interference does not occur between the information beam deriving directly from the light source 51 and the information beam that has been reflected back by the reflective layer 44. The same is also true for the reference beam deriving directly from the light source 51 and the reference beam that has been reflected back by the reflective layer 44.

In order to stabilize the recorded hologram, an ultraviolet light source device 32 and an optical system for the ultraviolet light irradiation may be added, if necessary, in the holographic recording/reconstructing apparatus as shown in FIG. 4.

The read-out of the recorded data in the holographic recording medium 40 is as follows.

When the electromagnetic shutter 57 is shut, the reference beam which is P-polarized is solely incident on the split wave plate 59. The plane of polarization of the reference beam that has been incident on the right half of the split wave plate 59 is rotated +45° as it passes through to form the B-polarized beam. On the other hand, the plane of polarization of the reference beam that has been incident on the left half of the split wave plate 59 is rotated −45° as it passes through to form the A-polarized beam. The A-polarized beam and the B-polarized beam are incident on the holographic recording medium 40 through the objective lens 60. The objective lens 60 is located in such a way so that the two beams are both focused on the reflective layer 44 which is located underneath the transparent substrate 42, the recording layer 45 and the transparent substrate 41.

Distribution of optical characteristics corresponding to the data which have been recorded is formed in the recording layer 45 of the holographic recording medium 40. It follows that the A-polarized beam and the B-polarized beam incident on the holographic recording medium 40 are partly diffracted by the refractive index-modulated region 46 formed in the recording layer 45. The diffracted light passes through the transparent substrate as the reconstructed light. This refers to the reconstruction of the information beam.

The reconstructed beam from the holographic recording medium 40 is collimated by the objective lens 60, which is then incident on the split wave plate 59. The B-polarized beam incident on the right half of the split wave plate 59 is converted to a P-polarized beam, and the A-polarized beam incident on the left half of the split wave plate 59 is converted to a P-polarized light. In this way, reconstructed beam is obtained as the P-polarized beam.

The reconstructed beam passes through the polarizing beam splitter 58. The reconstructed beam which has transmitted through the polarizing beam splitter 58 partly transmits through the beam splitter 61 and the imaging lens 62, to form an image on a two-dimensional photodetector 63. The image that is detected on the photodetector 63 is the reconstruction of the image which had been displayed on the transmission spatial light modulator 55 when data were being recorded. In this manner, the data which has been recorded in the holographic recording medium 40 can be read out.

On the other hand, the remaining portion of the A-polarized beam and the B-polarized beam incident on the holographic recording medium 40 through the split wave plate 59 are reflected back by the reflective layer 44. The reflected A-polarized beam and the B-polarized beam are collimated by the objective lens 60. When A-polarized beam passes through the right half of the split wave plate 59, it is converted to an S-polarized beam. When the B-polarized beam passes through the left half of the split wave plate 59, it is converted to an S-polarized beam. The S-polarized beams that have passed through the split wave plate 59 are reflected by the polarizing beam splitter 61, and would not reach the two-dimensional photodetector 63. Therefore, the recording-reconstructing apparatus, as shown in FIG. 4, makes it possible to reconstruct the information with excellent signal-to-noise ratio.

The holographic recording medium according to the invention can suitably be multiplexed. The geometry of the holography that is suitable for multiplexing, can either be transmission or reflection.

It is possible, if necessary, to illuminate the recording layer 45 with a uniform light after recording to polymerize the remaining monomers. It is also possible to diffuse oxygen into the recording layer of the holographic recording medium under an oxygen-rich atmosphere after recording to quench the radical species within the holographic recording medium. As described above, the photo-iniferter allows the propagating chain terminal to remain active as long as energy such as heat or light is supplied even after it has once become dormant by the lack of energy source. Therefore, when alternative energy, different from the one for recording, is exposed into the recording layer after recording, the interference pattern that has been recorded as a hologram tends to be blurred from that immediately after recording. By carrying out the procedures described above, it is possible to suppress the polymerization reaction in the recording layer after recording which makes it possible to record a hologram that follows the interference pattern of the two beams with great accuracy.

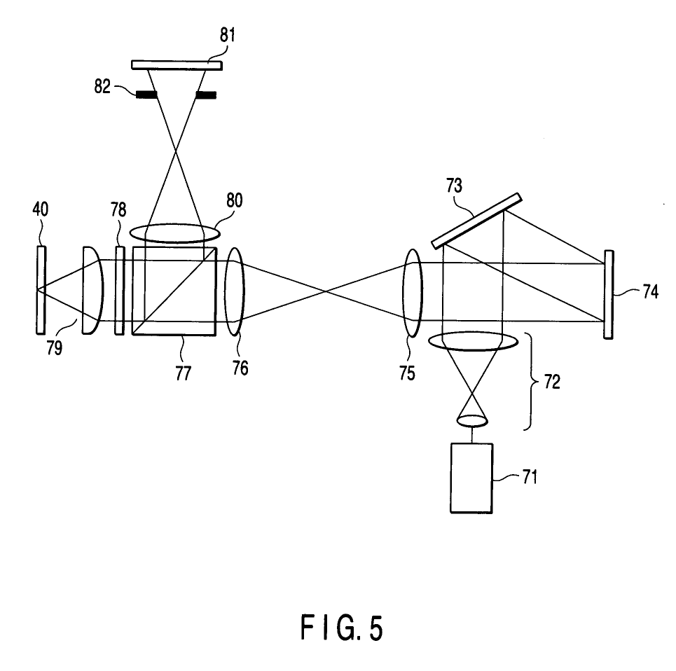

FIG. 5 schematically shows a holographic recording/reconstructing apparatus using the collinear interference geometry according to an embodiment of the invention. The construction of the apparatus will be described below in detail. The apparatus provides geometry of so-called collinear interference in which the information beam and the reference beam are modulated with a single spatial light modulator. Like the cases of the holographic recording/reconstructing apparatuses described above, it is preferable to use lasers that emit coherent and linearly polarized light beam for the light source 71. Examples of lasers include a semiconductor laser, a He—Ne laser, an argon laser and a YAG laser. The light source device 71 is also capable of controlling the wavelength of the light beam emitted therefrom. A beam expander 72 expands and collimates the light beam emitted from the light source device 71. The collimated light beam is reflected by a mirror 73 to the reflection spatial light modulator 74. The reflection type spatial light modulator 74 comprises a large number of pixels that are arrayed in a two-dimensional lattice. Each pixel on the reflection spatial light modulator 74 can independently change the direction or the polarization rotation of the reflected light. This enables to display information beam and reference beam simultaneously, where both beams are spatially modulated in a form of a two-dimensional pattern. The reflection spatial light modulators include, for example, a digital mirror device, a reflection liquid crystal device, or a reflection modulating device that operates under a magneto-optical effect. FIG. 5 shows the case where a digital mirror device is used as the reflection spatial modulator. The recording light reflected by the reflection spatial modulator 74 is incident on a polarizing beam splitter 77, after passing through imaging lenses 75 and 76. The direction of the polarization is adjusted in advance when beam is emitted from the light source device 71, in such a way that the recording light beam could transmit through the polarizing beam splitter 77. The recording light beam that has transmitted through the polarizing beam splitter 77 passes through a wave plate 78 and is incident on the holographic recording medium 40 after passing through an objective lens 79. The recording light is focused on the surface of the reflective layer 44 of the holographic recording medium 40. The wave plate 78 could be, for example a half-wave plate or a quarter-wave plate.

The reconstruction of the information beam is retrieved by the following procedures. When the reference beam which has been spatially modulated by the reflection spatial modulator 74 passes through the holographic recording medium 40, the spatially modulated reference beam is partly diffracted by the refractive index modulating region 46 to form a reconstructed information beam. The reconstructed light beam is reflected by the reflective layer 44 which then passes through the objective lens 79 and the wave plate 78. When passing through the wave plate 78, the plane of polarization of the reconstructed light beam is rotated so that the direction of the polarization is different from the original reference beam. The reconstructed and rotated information beam is reflected by the polarizing beam splitter 77. It should be noted that the rotating angle of the reconstructed information light beam at the wave plate 78 is preferably controlled in such a way that the reconstructed light beam reflects the highest at the polarizing beam splitter 77. The reconstructed light beam reflected by the polarizing beam splitter 77 is detected by a two-dimensional photodetector 81 as the reconstructed image of the information light beam. It should be noted that an iris diaphragm 82 is arranged in front of the photodetector 81 in order to improve the signal-to-noise ratio of the reconstructed information light beam.

[First Method of Manufacturing Master Hologram]

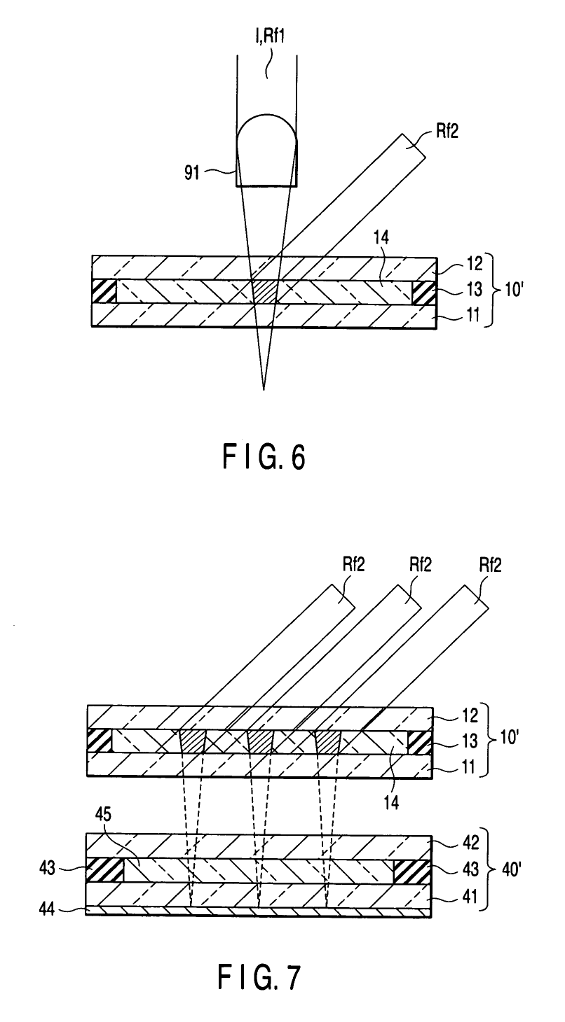

A first method of manufacturing a master hologram according to an embodiment of the invention will be described below. FIG. 6 is the illustration of the method. In order to manufacture a master hologram 10′, a transmission holographic recording medium, such as that shown in FIG. 1, is prepared. The recording layer 14 of the holographic recording medium is irradiated with collinearly interfered light beam that consists of information beam I and the first reference beam Rf1. The two collinearly interfered light beam here apparently act as an information beam of the two-axis holography. The position of the objective lens 91, through which the collinearly interfered light beam is transmitted, is controlled so as to allow the collinearly interfered light beam to be sufficiently defocused within the recording layer 14. In this manner, the collinearly interfered light beam and the second reference beam are interfered with each other within the recording layer 14 for recording, thereby manufacturing the master hologram 10′. Although the transmission holographic recording medium is illustrated in FIG. 6, the same thing is also true for a reflection holographic recording medium.

[First Method of Manufacturing a Copy Hologram]

A first method to manufacture a copy hologram using the master hologram fabricated by the method shown in FIG. 6 will be described below. FIG. 7 is the illustration of the method. The holographic recording medium shown in FIG. 3, which is used for manufacturing a copy hologram 40′, is arranged below the master hologram 10′ fabricated by the method shown in FIG. 6. The master hologram 10′ is irradiated with the second reference beam Rf2 at the angle equal to that of the angle of the second reference beam Rf2, shown in FIG. 6 at the manufacturing process of the master hologram 10′. The diffracted light corresponds to the original collinearly interfered light beam. The holographic recording medium is illuminated with the diffracted light beam so as to manufacture the copy hologram 40′. At this time, the master hologram 10′ and the copy hologram 40′ are arranged such that the diffracted light from the master hologram 10′ is focused within the lower transparent substrate 41 or on the reflective layer 44 of the copy hologram 40′. The hologram in the master hologram 10′ may be partly irradiated with the second reference beam Rf2, one hologram at time. However, it is preferable that many holograms are entirely irradiated with the second reference beams Rf2. The master hologram can also have a reflective layer on the lower substrate as shown in FIG. 3. In this case, the holographic recording medium that is to be copied into will be located above the master hologram.

[Second Method of Manufacturing Master Hologram]

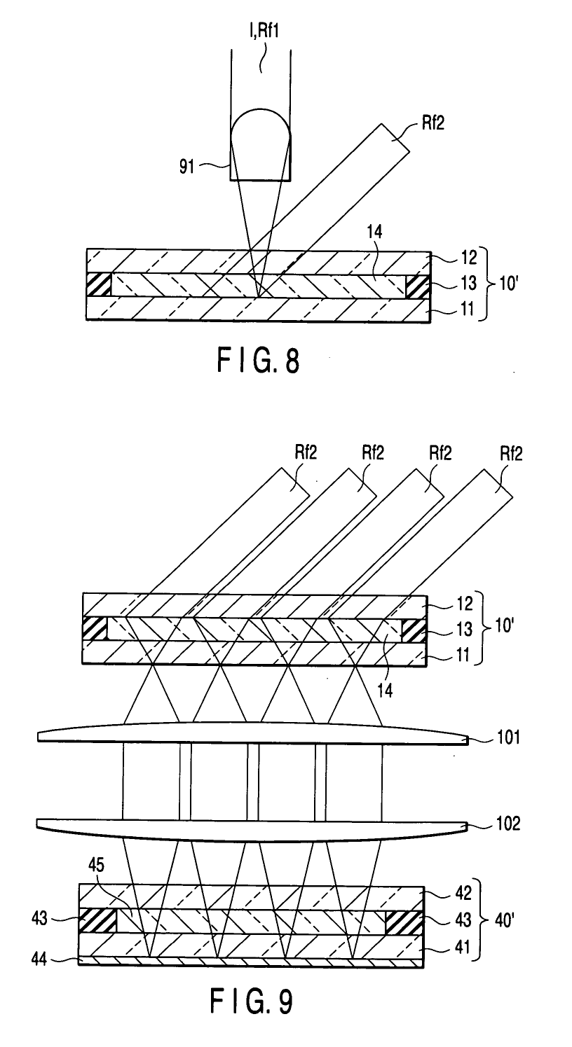

A second method of manufacturing a master hologram according to an embodiment of the invention will be described below. FIG. 8 is the illustration of the method. In order to manufacture a master hologram 10′, a transmission holographic recording medium, such as that shown in FIG. 1, is prepared. The recording layer 14 of the holographic recording medium is exposed to collinearly interfered beam that consists of information beam I and the first reference beam Rf1. The two collinearly interfered beams act as the information beam of the two-axis holography, since an alternative reference beam Rf2 is to be irradiated from direction different from the two collinearly interfered light beams, and interfered in the recording layer. The position of the objective lens 91 through which the collinearly interfered light beam is transmitted, is controlled so as to allow the collinearly interfered light beam to be focused within the transparent substrate 11 positioned at the opposite side of the incidence. In this manner, the collinearly light beam and the alternative reference beam Rf2 are interfered within the recording layer 14 for recording, thereby manufacturing the master hologram 10′. Although the transmission holographic recording medium is illustrated in FIG. 8, the same thing is true for the fabrication of the master reflection holographic recording media.

[Second Method of Manufacturing Copy Hologram]

A second method of manufacturing a copy hologram using the master hologram manufactured by the method shown in FIG. 8 will be described below. FIG. 9 is the illustration of the method. An imaging lens 101, another imaging lens 102, and a holographic recording medium, shown in FIG. 3, which is used for manufacturing the copy hologram 40′, are arranged below the master hologram 10′ manufactured by the method shown in FIG. 8. The master hologram 10′ is irradiated with the second reference beam Rf2 at an angle equal to that of the angle of the second reference beam Rf2 at the manufacturing process of the master hologram. The irradiated reference beam is partly diffracted which corresponds to the original collinearly interfered light beam that consists of information beam I and the reference beam Rf, as stated above. The reconstructed collinearly interfered light beam passes through the first lens 101 and the second lens 102. The master hologram 10′, the imaging lens 101, the imaging lens 102, and the copy holographic recording media 40′ are arranged in such a way that the reconstructed collinearly interfered light beam from the master hologram 10′ is focused within the transparent substrate 41 of the holographic recording media 40′ that is to be copied, positioned at the opposite side of the incidence. The hologram in the master hologram 10′ may partly be irradiated with the second reference beam Rf2 one hologram at a time. However, it is also possible that many holograms are entirely irradiated with the second reference beams Rf2, retrieving many diffracted light beams which are to be irradiated on the holographic recording medium.

If the master hologram has a reflective layer underneath the recoding layer, or if the master hologram is a reflection hologram, the holographic recording medium that is to be copied, has to be arranged above the master hologram.

### EXAMPLES

The present invention will be described in details with reference to Examples of the invention.

### Example 1

First, 2.16 g of 1,6-hexanediol diglycidyl ether (denacol Ex-212, Nagase Chemtex) as an epoxy compound, 4.80 g of dodecenyl succinic anhydride as a curing agent, and 0.39 g of 2,4,6-tribromophenyl acrylate as a photoactive monomer were mixed and dissolved to prepare a uniform solution. Then, 0.033 g of Irgacure [registered trademark] 784 (Ciba Specialty Chemicals) as a photoinitiator, and 0.046 g of bis(diethylthiocarbamoyl) disulfide (Tokyo Kasei) as a photo-iniferter were added to the resultant solution and were dissolved completely. Fifty μL of 2,4,6-tris(dimethylaminomethyl)phenol (DMP-30, Polysciences) were added to the solution before it was defoamed to provide a precursor solution for the recording layer.

The precursor solution for the recording layer was injected into the gap between two glass substrates arranged with a spacer of a polytetrafluoroethylene (PTFE) sheet interposed therebetween. The resultant structure was heated to 60° C. in an oven for 45 hours, thereby providing a sample of a holographic recording medium having a recording layer of 200 μm in thickness. The polymeric matrix was cross-linked and the layer was firm and solid. To avoid any unwanted exposures from light, all of the procedures stated above were operated under red light.

The sample was mounted on a rotation stage 20 of the holographic recording/reconstructing apparatus shown in FIG. 2 to record a hologram. A semiconductor laser with a wavelength of 405 nm was used as the light source device 21. The diameters of the information beam I and the reference beam Rf were both set to be 5 mm on the sample. The power density of the recording light, which is the sum of the power density of the information beam and the reference beam, was set to be 7 mW/cm².

After recording, the sample was allowed to be exposed only to the reference beam Rf by shutting the electromagnetic shutter 28 down. Diffracted light beam from the sample was observed, which indicates that a transmission hologram was successfully recorded in the recording layer of the sample. External diffraction efficiency (ηₑₓ) was calculated based on the following formula: ηₑₓ=I_{d}/I₀, where I₀ is the intensity of the illuminating light beam when the holographic recording medium 12 was irradiated with the reference beam Rf alone, and I_{d} is the intensity of the diffracted light beam detected by the photodetector 30. The internal diffraction efficiency (ηᵢₙ) was calculated by the following formula: ηᵢₙ=I_{d}/(Iₜ+I_{d}), where I_{d} is the intensity of the diffracted light beam detected by the photodetector 30 when the holographic recording medium 10 was irradiated with the reference beam Rf alone, and Iₜ is the intensity of the transmitted light beam detected by the photodetector 31. Square root of the internal diffraction efficiency to the cumulative exposure was plotted. Sensitivity was defined as the gradient in the rise of the square root of the internal diffraction efficiency as a function of cumulative exposure and its value was 1.6×10⁻³ cm²/mJ.

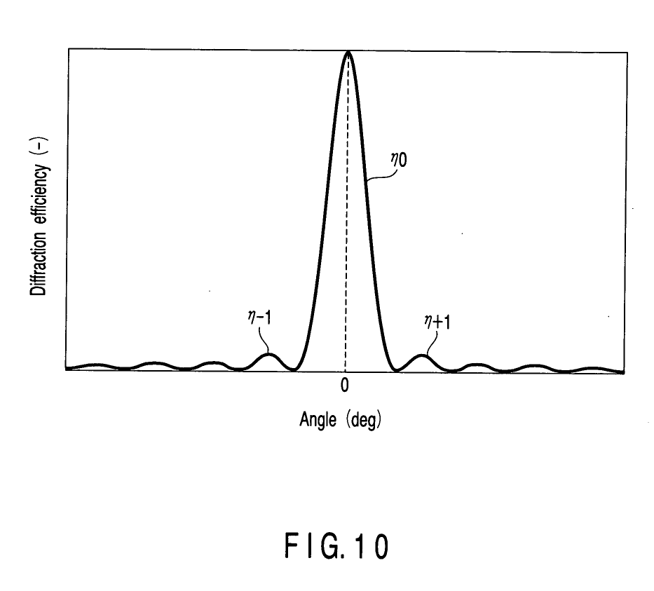

FIG. 10 is a plot showing the angle dependency of the diffraction efficiency for an ideal hologram. As shown in the plot, the intensity of diffraction efficiency is greatly dependent on the incident angle of the reference beam (Bragg mismatch factor). The intensity reaches its highest when the recorded hologram is exposed to a reference beam that is incident on the hologram from the angle equal from that of the reference beam when recording (the angle 0 shown in FIG. 10). When the angle of the reference beam is deviated toward the positive side (+) or the negative side (−) from the angle 0, the intensity of the diffraction efficiency decreases in a sinusoidal manner. In other words, the signal intensity periodically exhibits local maximum values relative to the deviation from the incident angle of the reference beam in recording. The increase in each of these local maximum values leads to a noise in the reconstructed signal and therefore is not desirable.

In this Example, the ratio of η₁/η₀ was calculated, where η₀ is the external diffraction efficiency of the hologram at the angle that has been recorded, and η₁ is the average of the local maximum values of the external diffraction coefficient η₊₁ and η₋₁ after the first null on the positive (+) and negative (−) sides, respectively. The smaller value in η₁/η₀ implies the higher reconstruction contrast. The measurements were performed immediately after the recording and an hour after. Table 1 shows the measurement result of the ratio η₁/η₀.

### Comparative Example 1

A sample that contains no bis(diethylthiocarbamoyl) disulfide was manufactured and evaluated as in Example 1. The sensitivity was 1.6×10⁻³ cm²/mJ. Table 1 shows the measurement result of the ratio η₁/η₀.

TABLE 1

| | | η₁/η₀ | η₁/η₀ |
|---|---|---|---|
| | | immedeately | one hour |
| | Sensitivity | after recording | after recording |
| | (cm²/mJ) | (−) | (−) |
| Example 1 | 1.6 × 10⁻³ | 0.05 | 0.10 |
| Comparative | 1.6 × 10⁻³ | 0.10 | 0.47 |
| Example 1 | | | |

As shown in Table 1, the sample of Example 1 exhibits the reconstruction contrast higher than that of the result from Comparative Example 1.

### Comparative Example 2

4.53 g of 1,6-hexanediol glycidyl ether (denacol [registered trademark] Ex-212, Nagase Chemtex), 1.42 g of tetraethylenepentamine (Wako Pure Chemical Industries), 1.05 g of N-vinylcarbazole (Tokyo Kasei), and 0.035 g of Irgacure [registered trademark] 784 (Ciba Specialty Chemicals) were mixed and stirred to prepare a precursor solution A for the recording layer.

The precursor solution A for the recording layer was injected into the gap between two glass substrates arranged with a spacer of a PTFE sheet interposed therebetween. It was then kept stand for 24 hours at room temperature under absence of light providing a sample of a holographic recording medium having a recording layer with a thickness of 200 μm. The polymeric matrix was cross-linked and the layer was firm and solid.

The sample was mounted on the rotation stage 20 of the holographic recording/reconstructing apparatus shown in FIG. 2 to record a hologram. A semiconductor laser with a wavelength of 405 nm was used as the light source device 21. Both of the diameters of the information beam I and the reference beam Rf were set to be 5 mm on the sample. The power density of the recording light, which is the sum of the power density of the information beam and the reference beam, was set to be 7 mW/cm². The sensitivity of the sample, which was calculated as in Example 1, was 1.9×10⁻³ cm²/mJ. Also, the ratio η₁/η₀ was measured immediately after the recording and after 30 minutes. Table 2 shows the results.

### Example 2

A precursor solution B for the recording layer was prepared by adding 0.040 g of benzyl N,N-diethyldithiocarbamate as a photo-iniferter to the precursor solution A prepared under the same conditions as in Comparative Example 2. A sample of holographic recording medium was fabricated in the same manner as in Comparative Example 2 using the solution B. Evaluations were also performed under the same manner as in Comparative Example 2. Results are shown in Table 2.

### Example 3

A precursor solution C for the recording layer was prepared by adding 0.066 g of p-xylene bis(N,N-diethyldithiocarbamate) as a photo-iniferter to the precursor solution A prepared under the same conditions as in Comparative Example 2. A sample of holographic recording medium was fabricated in the same manner as in Comparative Example 2 using the solution C. Evaluations were also performed under the same manner as in Comparative Example 2. Results are shown in Table 2.

### Example 4

A precursor solution D for the recording layer was prepared by adding 0.046 g of bis(N,N-diethylthiocarbamoyl) disulfide as a photo-iniferter to the precursor solution A prepared under the same conditions as in Comparative Example 2. A sample of holographic recording medium was fabricated in the same manner as in Comparative Example 2 using the solution D. Evaluations were also performed under the same manner as in Comparative Example 2. Results are shown in Table 2.

### Example 5

A precursor solution E for the recording layer was prepared by adding 0.036 g of diphenyl disulfide as a photo-iniferter to the precursor solution A prepared under the same conditions as in Comparative Example 2. A sample of holographic recording medium was fabricated in the same manner as in Comparative Example 2 using the solution E. Evaluations were also performed under the same manner as in Comparative Example 2. Results are shown in Table 2.

### Example 6

A precursor solution F for the recording layer was prepared by adding 0.057 g of diphenyl sulfide as a photo-iniferter to the precursor solution A prepared under the same conditions. A sample of holographic recording medium was fabricated in the same manner as in Comparative Example 2 using the solution F. Evaluations were also performed under the same manner as in Comparative Example 2. Results are shown in Table 2.

TABLE 2

| | | η₁/η₀ | η₁/η₀ |
|---|---|---|---|
| | | immedeately | 30 minutes |
| | Sensitivity | after recording | after recording |
| | (cm²/mJ) | (−) | (−) |
| Comparative | 1.9 × 10⁻³ | 6.2 × 10⁻² | 1.2 × 10⁻¹ |
| Example 2 | | | |
| Example 2 | 1.6 × 10⁻³ | 1.7 × 10⁻² | 6.5 × 10⁻² |
| Example 3 | 1.9 × 10⁻³ | 2.1 × 10⁻² | 5.6 × 10⁻² |
| Example 4 | 1.4 × 10⁻³ | 3.8 × 10⁻² | 7.2 × 10⁻² |
| Example 5 | 6.0 × 10⁻⁴ | η₁ was not | η₁ was not |
| | | observed | observed |
| Example 6 | 1.5 × 10⁻³ | 3.4 × 10⁻³ | 1.7 × 10⁻² |

As shown in Table 2, all of the results from Examples 2 to 6 exhibited a reconstruction contrast higher than that of the result from Comparative Example 2.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A holographic recording medium comprising a recording layer, the recording layer comprising:
a matrix material;
a polymerizable monomer having at least one ethylenic unsaturated bond;
a photo-iniferter ; and
a photoinitiator.

2. The holographic recording medium according to claim 1, wherein the photo-iniferter is represented by the general formula given below:
R₁—S—R₂,
R₃—S—S—R₄, or
R₅—(C—S—C(═S)—N—(R₆))ₙ,
where each of R₁, R₂, R₃, and R₄ is a substituent having a phenyl group, a thiocarbonyl group or a benzoyl group, R₅ is a phenyl group, R₆ is an alkyl group, and n is an integer of 2 to 4.

3. The holographic recording medium according to claim 2, wherein the photo-iniferter is selected from the group consisting of diphenyl sulfide, diphenyl disulfide, bis(N,N-diethylthiocarbamoyl) disulfide, benzoyl disulfide, benzyl N,N-diethyldithiocarbamate, p-xylene bis(N,N-diethyldithiocarbamate), 1,2,4,5-tetrakis(N,N-diethyldithiocarbamylmethyl)benzene.

4. The holographic recording medium according to claim 1, wherein the matrix material is formed of a cured resin of an epoxy compound with a curing agent.

5. The holographic recording medium according to claim 4, wherein the curing agent is selected from the group consisting of amine, phenol, organic acid anhydride, and amide.

6. The holographic recording medium according to claim 1, wherein an amount of the polymerizable monomer is 1 to 50% by weight based on the recording layer.

7. The holographic recording medium according to claim 1, wherein the amount of the photoinitiator is 0.1 to 20% by weight based on the recording layer.

8. The holographic recording medium according to claim 1, wherein an amount of the photo-iniferter is 0.3 to 12 mol % based on the polymerizable monomer.

9. The holographic recording medium according to claim 1, wherein the recording layer is sandwiched between a pair of transparent substrates.

10. The holographic recording medium according to claim 9, wherein one of the transparent substrates is provided with a reflective layer.

11. A method of manufacturing a holographic recording medium, comprising:
irradiating the holographic recording medium according to claim 1 with recording light; and
irradiating the holographic recording medium with uniform light so as to polymerize a remaining polymerizable monomer.

12. A method of manufacturing a holographic recording medium, comprising:
irradiating the holographic recording medium according to claim 1 with recording light; and
allowing oxygen to diffuse into the recording layer of the holographic recording medium in an oxygen-rich atmosphere to deactivate the radical species in the recording layer.

13. A method of manufacturing a master hologram, comprising:
irradiating the recording layer of the holographic recording medium according to claim 1 with information beam and first reference beam collinearly; and
irradiating the recording layer with a second reference beam at an angle different from that of the information beam so as to make the information beam, the first reference beam and the second reference beam interfere in the recording layer to perform recording.

14. A method of manufacturing a copy hologram, comprising:
arranging the master hologram manufactured by the method according to claim 13 to face a holographic recording medium;
irradiating the master hologram with the second reference beam at the angle equal to that in manufacturing of the master hologram to generate diffracted light; and
irradiating the recording layer of the holographic recording medium with the diffracted light to perform recording.

15. The method according to claim 14, wherein the holographic recording medium is one according to claim 1.
